(19) United States
(12) Patent Application Publication
(10) Pub. No.: US 2024/0104641 A1
(43) Pub. Date: Mar. 28, 2024

(54) SYSTEM AND METHOD OF PROVIDING ACCESS TO ONE OR MORE TECHNOLOGIES VIA A RENTAL PLATFORM

(71) Applicant: Christopher M. Karl, Swansboro, NC (US)

(72) Inventor: Christopher M. Karl, Swansboro, NC (US)

(21) Appl. No.: 18/371,112

(22) Filed: Sep. 21, 2023

Related U.S. Application Data
(60) Provisional application No. 63/409,503, filed on Sep. 23, 2022.
(60) Provisional application No. 63/450,868, filed on Mar. 8, 2023.

(51) Int. Cl. G06Q 30/0645; G06Q 10/02; G06Q 30/0207; G06Q 30/0282; G06Q 30/0601; H04L 9/00

(52) U.S. Cl. CPC G06Q 30/0645; G06Q 10/02; G06Q 30/0207; G06Q 30/0282; G06Q 30/0623; G06Q 30/0639; G06Q 30/0643; H04L 9/50

(57) ABSTRACT

The invention is a system and method of providing combinations of electric technologies to local communities. The electric products (e.g., cars, lawn mowers, scooters, and the like) can be geographically valued to a user's particular local community via selected combinations. The geographically valued system serves local communities where the facilities and access points are physically located. With proper integration of the electric products, the general population can regularly afford to participate in eco-friendly alternatives to petroleum-based products.

### CROSS-REFERENCE TO RELATED APPLICATIONS

This application claims priority to U.S. Provisional Patent Application No. 63/409,503, filed Sep. 23, 2022 and 63/450,868 filed Mar. 8, 2023, both of which are incorporated by reference herein in their entireties.

### TECHNICAL FIELD

The presently disclosed subject matter is generally directed to a system and method of providing increased access to electric technologies to a wide population of users, thereby decreasing the dependence on petroleum-based products. The presently disclosed subject matter is further directed to a rental management system, specifically the utilization of blockchain, smart contracts, and NFT (non-fungible token) technology for use with and in rental equipment. The presently disclosed subject matter therefore is configured to revolutionize the sharing economy and its potential by transforming one or more idle assets into rental opportunities.

### BACKGROUND

Inflation suggests that people must sustainably do more with less. The increasing price of gasoline acts as a hindrance to society, causing large portions of the population to economically struggle and excessively pay for the operation of their petroleum-based products (e.g., cars and trucks). While electric technologies offer many benefits to users, these products are not universally available due to their inflated purchase prices, and thus are not fully integrated into society. For example, the materials required to construct batteries for electric technologies are increasingly costly to the average user, making the products difficult to obtain and use. Further, due to the increasing demand for electric technologies within the limited supply of materials, the purchase price for electric products continues to increase. As a result, it has proven difficult for a vast number of consumers to effectively contribute to ongoing environmental decarbonizing efforts by purchasing and using electric technologies. Instead, the general population must continue to rely on the use of petroleum-based products.

In addition, the traditional rental market has been plagued with inefficiencies, lack of transparency, and limited trust. As a result, both property owners and renters have experienced frustration and financial losses. Further, communication breakdowns, maintenance issues, and disputes frequently arise that create a negative rental experience. Finally, the rise of online rental platforms has led to security concerns and a lack of comprehensive solutions for renters and owners.

In response, the disclosed Decentralized Asset Rental Management System (DARMS) has been developed to revolutionize the rental management industry by utilizing state-of-the-art blockchain, smart contracts, and NFT technology to effectively overcome the limitations of traditional systems. Specifically, traditional rental management systems often suffer from intermediaries, inefficiencies, and security risks. In response, DARMS offers a simplified and transparent rental process, removes intermediaries, reduces costs, and improves security. Further, DARMS offers a user-friendly interface, an integrated reservation and payment system, a comprehensive review and rating system, direct communication tools, advanced reporting and analytics, and a mobile application. With such innovative features, DARMS advantageously streamlines and enhances the rental experience for both property owners and renters, providing a unique and cutting-edge solution to the rental management industry.

It would therefore be beneficial to provide a system and method that allows increased access and use of electric technologies to isolate inflation, reduce and/or eliminate the total cost of ownership over time, and increase the decarbonizing effort on the environment.

### SUMMARY

In some embodiments, the presently disclosed subject matter is directed to a rental management system that utilizes blockchain, smart contracts, and NFTs to offer a secure and efficient rental process for property owners and renters.

The term “blockchain” refers to any of several types of electronic, computer-based, distributed ledgers. For example, the term can include a public ledger that records peer-to-peer digital transactions (such as Bitcoin transactions). Thus, a blockchain is a distributed ledger with growing lists of records (blocks) that are securely linked together via cryptographic hashes. Each block contains a cryptographic hash of the previous block, a timestamp, and/or transaction data (generally represented as a Merkle tree, where data nodes are represented by leaves). Since each block contains information about the previous block, they effectively form a chain (compare linked list data structure), with each additional block linking to the ones before it. Consequently, blockchain transactions are irreversible in that, once they are recorded, the data in any given block cannot be altered retroactively without altering all subsequent blocks. Blockchains are typically managed by a peer-to-peer (P2P) computer network for use as a public distributed ledger, where nodes collectively adhere to a consensus algorithm protocol to add and validate new transaction blocks. Although blockchain records are not unalterable, since blockchain forks are possible, blockchains may be considered secure by design and exemplify a distributed computing system with high Byzantine fault tolerance.

The term “smart contracts” refers to a computer program or a transaction protocol that is intended to automatically execute, control, or document events and actions according to the terms of a contract or an agreement. The objectives of smart contracts are the reduction of need for trusted intermediators, arbitration costs, and fraud losses, as well as the reduction of malicious and accidental exceptions. Smart contracts are commonly associated with cryptocurrencies, and the smart contracts introduced by Ethereum™ are generally considered a fundamental building block for decentralized finance (DeFi) and NFT applications. Smart contracts are not legal agreements, but rather means of performing obligations deriving from agreements that can be executed automatically by a computer program or a transaction protocol, such as technological means for the automation of payment obligations or obligations consisting in the transfer of tokens or cryptocurrencies. Similar to a transfer of value on a blockchain, deployment of a smart contract on a blockchain occurs by sending a transaction from a wallet for the blockchain. The transaction includes the compiled code for the smart contract as well as a special receiver address. The transaction must then be included in a block that is added to the blockchain, at which point the smart contract's code will execute to establish the initial state of the smart contract. Byzantine fault-tolerant algorithms secure the smart contract in a decentralized way from attempts to tamper with it. Once a smart contract is deployed, it cannot be updated. Smart contracts on a blockchain can store arbitrary state and execute arbitrary computations. End clients interact with a smart contract through transactions. Such transactions with a smart contract can invoke other smart contracts. These transactions might result in changing the state and sending coins from one smart contract to another or from one account to another.

The term “NFT” refers to a unique digital identifier that is recorded on a blockchain, and is used to certify ownership and authenticity. NFTs cannot be copied, substituted, or subdivided. The ownership of an NFT is recorded in the blockchain and can be transferred by the owner, allowing NFTs to be sold and traded. NFTs can be created by anyone and require few or no coding skills to create. NFTs typically contain references to digital files such as artworks, photos, videos, and audio. Because NFTs are uniquely identifiable, they differ from cryptocurrencies, which are fungible. Thus, an NFT is a data file, stored on a type of digital ledger called a blockchain, which can be sold and traded. The NFT can be associated with a particular asset (e.g., digital or physical), such as an image, art, music, or recording of a sports event. It may confer licensing rights to use the asset for a specified purpose. An NFT (and, if applicable, the associated license to use, copy, or display the underlying asset) can be traded and sold on digital markets. NFTs function like cryptographic tokens, but unlike cryptocurrencies, NFTs are typically not mutually interchangeable, so they are not fungible. A non-fungible token contains data links, for example which point to details about where the associated art is stored, that can be affected by link rot.

The disclosed system eliminates intermediaries, reducing the risk of fraud or error in the rental process, and offers a centralized database, user-friendly interface management system for owners, captivating marketplace for renters, integrated reservation and payment system, comprehensive review and rating system, direct communication tools, advanced reporting and analytics, and a mobile application for the management of rental assets. The system can be used to manage the rental of various types of assets and can be customized to suit the needs of different users and asset types.

Advantageously, the disclosed system can reduce costs for both renters and property owners and increases the efficiency of the rental process. The system therefore provides a unique and innovative solution for property owners, renters, and existing businesses that offers a secure and efficient means of managing rental assets. The platform is designed to be scalable, performant, and secure, with measures taken to mitigate potential attack vectors and security risks. The system is capable of revolutionizing the rental management industry and provides a unique and novel approach to managing rental assets.

In some embodiments, the presently disclosed subject matter is directed to a method for bundling and renting one or more electric technologies. Particularly, the method comprises receiving via a communication interface, from each of a plurality of electric technologies made available for use on demand, data representing one or more of a location and an availability state of the electric technologies. The method also includes using a processor to use the received location and availability state data to determine a set of electric technologies currently available to be used and provide via the communication interface to each of a plurality of user data indicating the respective locations of one or more electric technologies currently available for use by the user within an area of interest associated with the user.

In some embodiments, the plurality of electric technologies is provided within the local geographic region of the user.

In some embodiments, the local geographic region is about 50, 40, 30, 20, 10 or less miles from the location of the user.

In some embodiments, the electric technology is selected from a combination of 2, 3, 4, 5, or more electric technologies.

In some embodiments, the plurality of electric technologies are selected from electric cars, electric trucks, electric motorcycles, electric boats, electric jet skis, electric buggies, electric go-karts, electric motorsports, electric scooters, electric three-wheelers, electric agricultural equipment, electric off-road vehicles, electric artificial intelligence robots, electric virtual reality/augmented wearable gear, or combinations thereof.

In some embodiments, the electric technologies are related in application, related in use, or both.

In some embodiments, the method provides access to the electric technologies to the user.

In some embodiments, the method further includes NFT technology configured for use as discounted coupons used towards rental of the electric technologies.

In some embodiments, the NFTs can be transferred, traded, tracked, utilized, or combinations thereof.

In some embodiments, the NFTs are marketed through social media platforms, text messages, or combinations thereof.

In some embodiments, the presently disclosed subject matter is directed to a system for managing the bundling and renting of one or more electric technologies. Specifically, the system comprises a communication interface. The system also includes a processor coupled to the communication interface and configured to receive via the communication interface from each of a plurality of electric technologies made available for use representing one or more of a location and an availability state of the vehicle; use the received location and availability data to determine a set of electric technologies currently available to be selected; and provide data indicating the availability data to the user. The user can select one or more electric technologies to rent in exchange for the payment of a fee.

In some embodiments, the presently disclosed subject matter is directed to a rental management system comprising a decentralized platform that utilizes blockchain, smart contracts, and NFTs to provide a secure and efficient rental process for property owners and renters. The term “decentralized” refers to performing data communication with each other rather than requiring a given device to communicate via a designated (e.g., central) network entity, such as a server device.

In some embodiments, the system comprises a centralized database that serves as the backbone of the system, enabling a user-friendly interface to provide seamless and intuitive rental asset management.

In some embodiments, the rental management system comprises an integrated reservation and payment system that streamlines the rental process, allowing renters to easily secure and pay for their rental properties. The term “streamlined” refers to the increased efficiency and/or simplicity of the system when compared to prior art rental systems.

In some embodiments, the system comprises a comprehensive review and rating system that enhances transparency and accountability, enabling users to share feedback with other members of the platform.

In some embodiments, the system comprises direct communication tools that facilitate efficient and direct conversations between property owners and renters. Direct communication tools include those that allow communication between two or more adjacent devices (e.g., computers, phones, laptops, etc.).

In some embodiments, the system comprises advanced reporting and analytics features that provide real-time monitoring of the rental process, offering data-driven insights to optimize rental operations. “Analytics” refers to the data analytics for the managed networks and servers. Analytics and reporting are used for the discovery, interpretation, and communication of meaningful patterns in data. They also can include applying data patterns toward effective decision-making. Analytics can rely on the simultaneous application of statistics, computer programming, and operations research to quantify performance.

In some embodiments, the system comprises a mobile application for the management of rental assets. As such, the system can offer users the flexibility to access the platform on-the-go, anytime, and anywhere. The term “mobile application” refers to any application, program, or service that can be installed on the user's mobile device and that executes on the user's mobile device. The mobile application can be accessible by the general public through an application marketplace server and shown to members.

In some embodiments, each NFT includes a unique identification number that provides an immutable and secure record of the rental asset, and critical information such as the rental period, rental price, and specifications of the rental asset, allowing efficient tracking of rental asset ownership and enhancing transparency and accountability throughout the rental process.

In some embodiments, a smart contract is used to automate the rental process and enforce predetermined rules and conditions, including essential details such as rental price, rental period, and payment method, reducing the need for intermediaries and lowering costs.

In some embodiments, the system is used to manage the rental of various types of assets and can be customized to suit the needs of different users and asset types.

In some embodiments, the incorporation of augmented reality technology further enhances the user experience by providing a fully immersive and interactive experience for users to preview rental items before committing to a rental agreement.

### BRIEF DESCRIPTION OF THE DRAWINGS

FIG. 1 is an image of one method of using a system in accordance with some embodiments of the presently disclosed subject matter.

FIG. 2 is a flow chart illustrating one method of using the system in accordance with some embodiments of the presently disclosed subject matter.

FIG. 3 is a flow chart illustrating the chain from renewable resources to consumers in accordance with some embodiments of the presently disclosed subject matter.

FIG. 4 is an illustration of a system in accordance with some embodiments of the presently disclosed subject matter.

FIG. 5 is a schematic that illustrates a rental management solution in accordance with some embodiments of the presently disclosed subject matter.

FIG. 6 is a schematic that illustrates the role of NFTs in a rental management process in accordance with some embodiments of the presently disclosed subject matter.

FIG. 7 is a schematic that illustrates the role of smart contracts in automating rental transactions in accordance with some embodiments of the presently disclosed subject matter.

### DETAILED DESCRIPTION

The presently disclosed subject matter is introduced with sufficient details to provide an understanding of one or more particular embodiments of broader inventive subject matters. The descriptions expound upon and exemplify features of those embodiments without limiting the inventive subject matters to the explicitly described embodiments and features. Considerations in view of these descriptions will likely give rise to additional and similar embodiments and features without departing from the scope of the presently disclosed subject matter.

Unless defined otherwise, all technical and scientific terms used herein have the same meaning as commonly understood to one of ordinary skill in the art to which the presently disclosed subject matter pertains. Although any methods, devices, and materials similar or equivalent to those described herein can be used in the practice or testing of the presently disclosed subject matter, representative methods, devices, and materials are now described.

Following long-standing patent law convention, the terms “a”, “an”, and “the” refer to “one or more” when used in the subject specification, including the claims. Thus, for example, reference to “a device” can include a plurality of such devices, and so forth. It will be further understood that the terms “comprises,” “comprising,” “includes,” and/or “including” when used herein specify the presence of stated features, integers, steps, operations, elements, and/or components, but do not preclude the presence or addition of one or more other features, integers, steps, operations, elements, components, and/or groups thereof.

Unless otherwise indicated, all numbers expressing quantities of components, conditions, and so forth used in the specification and claims are to be understood as being modified in all instances by the term “about”. Accordingly, unless indicated to the contrary, the numerical parameters set forth in the instant specification and attached claims are approximations that can vary depending upon the desired properties sought to be obtained by the presently disclosed subject matter.

As used herein, the term “about”, when referring to a value or to an amount of mass, weight, time, volume, concentration, and/or percentage can encompass variations of, in some embodiments+/−20%, in some embodiments+/−10%, in some embodiments+/−5%, in some embodiments+1-1%, in some embodiments+/−0.5%, and in some embodiments +/−0.1%, from the specified amount, as such variations are appropriate in the disclosed packages and methods.

As used herein, the term “and/or” includes any and all combinations of one or more of the associated listed items.

Relative terms such as “below” or “above” or “upper” or “lower” or “horizontal” or “vertical” may be used herein to describe a relationship of one element, layer, or region to another element, layer, or region as illustrated in the drawing figures. It will be understood that these terms and those discussed above are intended to encompass different orientations of the device in addition to the orientation depicted in the drawing figures.

The embodiments set forth below represent the necessary information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure and the accompanying claims.

The presently disclosed subject matter is directed to a system and method of providing combinations of electric technologies to local communities. The term “electric technology” refers to the use of technology related to providing electric energy to power an item. In some embodiments, the electric product can refer to an electric vehicle that operates using electricity as a power supply source. Thus, the electric product can include a battery that can be charged as a power supply source, such that the product can be operated using electric energy stored in the battery. As such, the electric technology product does not rely on or use petroleum-based products.

As noted above, the disclosed system and method can include the use of blockchain technology, smart contracts, and/or NFTs. As noted above, blockchain technology includes a decentralized, digital ledger that records transactions in a secure and transparent manner. Further, smart contracts include self-executing contracts with the terms of the agreement between buyer and seller being directly written into lines of code. “Non-Fungible Tokens (NFTs)” refers to unique digital assets that represent ownership or proof of authenticity of a particular item or piece of content.

The term “local community” refers to a user's immediate geographic area. For example, a local community can include a 10, 20, 30, 40, or 50 mile radius from the user's location. However, it should be appreciated that a user's local community can be outside the range set forth above (e.g., less than about 10 miles or more than about 50 miles).

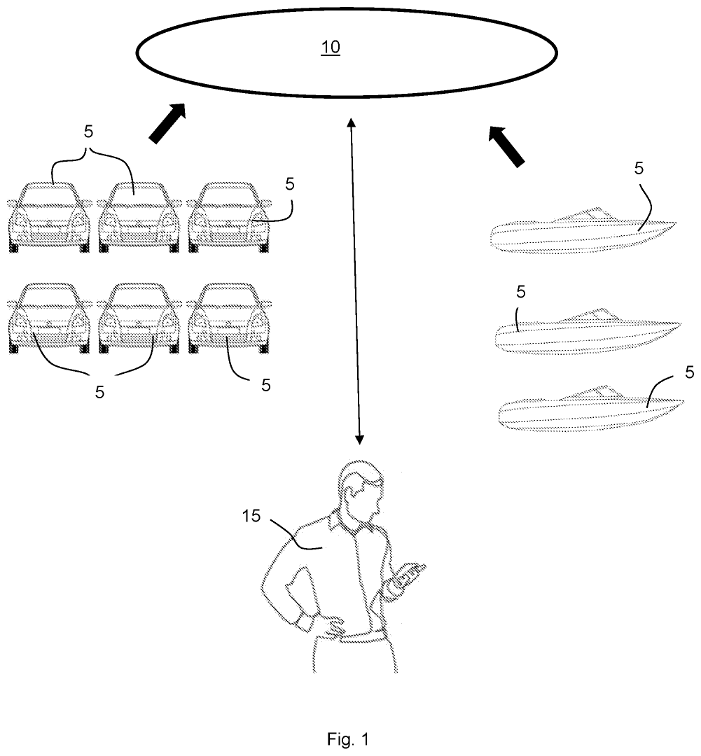

The electric products (e.g., cars, lawn mowers, scooters, and the like) can be geographically valued to a user's particular local community via selected combinations. Stated another way, one or more electric technologies can be bundled or combined at a single time for a given user. For example, each of a plurality of electric products 5 can transmit location data to cloud server 10, as shown in FIG. 1. A mobile application, website, smart device, or other device that communicates the location of one or more desired electric products. Thus, a particular user 15 can use the mobile application, website, and/or smart device to find, select, and bundle the rental of various electric products. The term “rental” refers to the temporary use of one or more bundled electronic technologies in exchange for a fee. Ownership remains with the buyer of the electric product. Electric products that are available for rental satisfy all conditions for being rentable by a user. For example, the electric product can be in a location that is geographically close to the user (e.g., within about 10, 20, 30, 40, 50 or more miles from the user's location) and has not been otherwise rented by another user. With the above configuration, the user can rent and use a combination of electric technologies that meet the requirement information.

Suitable electric technologies can include (but are not limited to) one or more of the following: electric cars, electric trucks, electric motorcycles, electric boats, electric jet skis, electric buggies, electric go-karts, electric motorsports, electric scooters, electric three-wheelers, electric agricultural equipment, electric off-road vehicles, electric artificial intelligence robots, electric virtual reality/augmented wearable gear, and the like. In some embodiments, two or more electric technologies can be bundled and rented together. In some embodiments, more than two electric technologies can be bundled together and rented. In some embodiments, the bundled electric technologies can be related in some way, such as in particular application (e.g., an electric lawn mower, electric weed eater, electric leaf blower can all be used for working in a user's yard). In other embodiments, the electric technologies can be bundled for a particular use (e.g., an electric truck and an electric boat can be rented for use on a vacation).

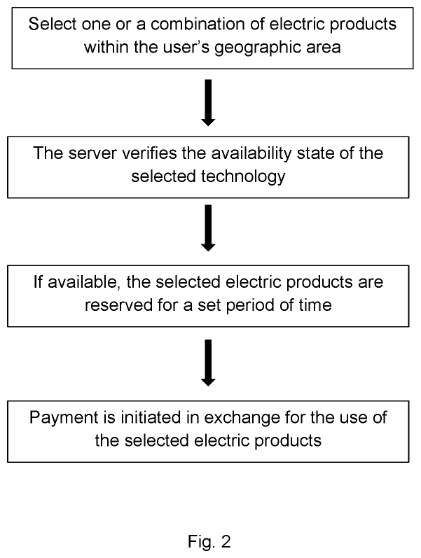

As shown in FIG. 2, in some embodiments, user 15 can use a computer, tablet, phone, or other device to access cloud 10 to find and select one or a combination of bundled electric technologies 5. To properly manage the electric technologies, the disclosed system needs to know where each technology is located and keep track of what user has rented each item and how much time has passed during the rental period. The computer or other device can provide a map-based or other user interface to locate technologies in an area of interest to the user (their current location, a future location, the location of a thirty party, for example). The corresponding locations can be displayed on the map for easy selection. For example, the default location may be a walkable radius from the geo-location of the mobile device. However, in some embodiments, the electric technologies can be delivered to the user.

Information and functionality to select and make payment for rental of electric technologies 5 can be provided through the mobile device or other user interface. For example, a user can claim or reserve an electric technology or combination of technologies. The rental information can include an identification number for identifying the particular electric technologies, a use period (rental period), a use fee, etc. In various embodiments, the system includes functionality to teach the user how to activate and use the electric technologies and to do so safely and while complying with local regulations.

In some embodiments, a backend server can be configured to receive information from each of a plurality of users. The server processes information received from the users to enable each user to select and reserve a specific electric technology or combination of technologies. In some embodiments, the server receives an identification of a specific electric technology requested, the server verifies the availability state of the technology (e.g., not already reserved or rented by another user, sufficient battery charge level, etc.) and if available associates the electric technology with the requesting user for use.

Each electric technology can be equipped with a corresponding computer system comprising a communication functionality, such as WiFi, Bluetooth, GPS, cellular, etc., enabling the electric product to connect directly or indirectly (e.g., via a user's mobile device) via the internet to a backend server. The connection may be via a direct wireless connection or an indirect wireless connection (e.g., via Bluetooth or other near field communication) to a user's mobile device.

In various embodiments, while a particular electric technology is in use by a user, the system can perform ongoing or scheduled monitoring of the electric product. For example, one or more of the following may be monitored and reported to the backend server: electric product charge level, speed, location, etc.

When the rental period ends, the user can either renew the rental period for a desired amount of time or can return one or more of the electric technologies. The mode of return of the product can be selectable by the user. For instance, the user can select a place they will return the electric technology. Alternatively, a pickup time can be scheduled from the user's location. The return location can be an agency of the main business operator or any other arbitrary place (a place that is selected by the user from a range of places where the main business operator can pick up the electric technology). The system can include a duration module configured to provide information on a duration for which an electric technology that is selected by the user is rented. The user can thus select the duration for which the electric technology is rented.

Advantageously, because the products are electric, the accessibility cost to the user is reduced compared to conventional petroleum-based competitive products. As a result, the disclosed system and method can be used to provide electric alternatives to conventional vehicles and other technologies that can be combined to replace everyday items that are powered with petroleum-based products. Accordingly, the use of the selected electric technology combinations can contribute to the environmental decarbonization effort.

Thus, the disclosed system and method fundamentally eliminate a user's need for ownership of one or a combination of electric technologies, thereby better integrating the technologies into society. The disclosed system consolidates comparably expensive electric technologies into a single convenient location. Providing users with uniquely affordable access to rental of electric product(s) allows users access to electric products in a cost-effective manner (e.g., without the obligation to own them).

Continuing, the disclosed combinations of electric technologies provide users with a convenience through use of smarter and cleaner technologies. For example, the electric technology can help users simplify daily tasks, better access information, employ safer transportation options, protect human health, and accelerate developmental applications.

In some embodiments, the system can cooperate and work directly with Web3 software developing companies (e.g., Dapper Labs) to employ NFTs. The term “NFT” or “non-fungible token” refers to a type of digital asset similar to cryptocurrency, but for which each NFT has its own unique information, attributes, or characteristics. For example, media content items such as artwork, audio files, video files, lyrics or other works can be associated with a nonfungible token. An NFT can include permanent, unalterable metadata that describes or defines it authenticity and it can be transferable in terms of ownership. In some embodiments, the NFTs can be used as discounted coupons towards a corresponding technology combination payment.

Thus, a user can create a working account capable of storing the NFTs between the accounts of various users. As a result, the simple exchange of typical currency (e.g., debit and credit cards) to be processed in exchange for signature NFT coupons that can be easily purchased. The NFT coupons can then be used to reserve one or more electric technologies as described above. As a buyer, seller, or investor in the NFTs or artwork in the form of transferable, tradeable, transaction contracts, the technology combination inventory will be tracked, traded, and utilized throughout use of the system and methods.

In some embodiments, the NFTs can be mass marketed through social media platforms and sent via text message, reflecting a visual NFT coupon that can be used to redeem a discounted electric technology combination experience in real life.

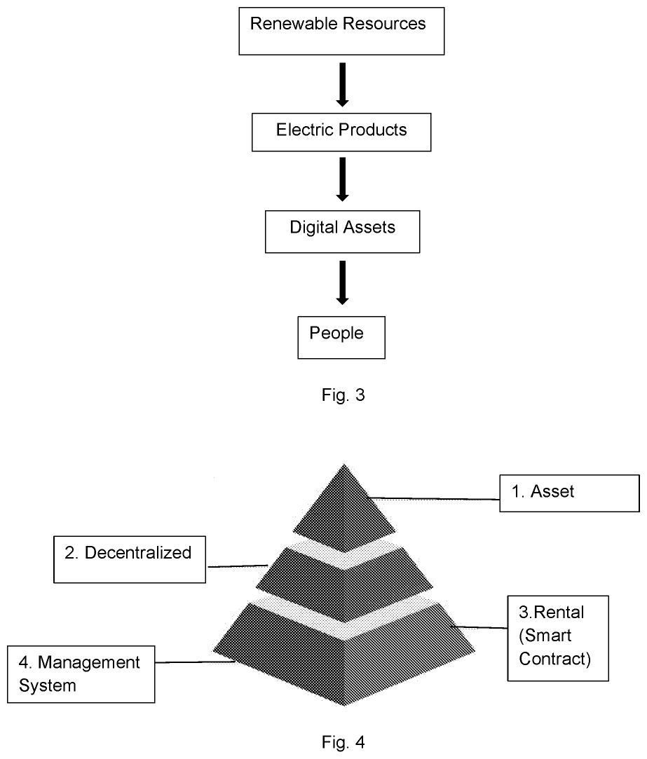

Thus, the disclosed system creates a novel digital method of providing a unique process of accessibility, as illustrated in FIG. 3. Particularly, existing companies have highly desired electric technologies that are expensive and unsold. By creating tradeable NFTs of the companies' electric products, the disclosed system can affordably offer electric technologies to the general population, as the costs to acquire the technology combinations are a fraction of what they would typically cost to purchase these electric technologies. As a result, the disclosed system and process of accessibility provides expensive electric technologies to millions of people, making the technologies an acquirable commodity for users that normally would be unable to afford quality combinations of the electric technologies.

The disclosed system and method present an opportunity for existing technology companies to have unused or idle electric inventory work better for them. Thus, the leased electric products become greater assets. Collectable, tradeable, utility-like contracts (e.g., smart contracts) are created and liked to each NFT representation of the electric products. User can then combine the NFTs to experience their technology combinations in real life.

The created NFT collections allow companies to delist, discount, replace, resell and/or reuse electric products easily and quickly. The companies will retain ownership of the electric products yet allow the electric products to be affordably accessed by a greater portion of users. The increased availability of electric products can present increased amounts of newly developed educational opportunities for existing companies and their employees. The unique electric services require increased on-site team members that can be easily and affordably retrained to do developmental work on a regular basis, potentially increasing minimum wage over time.

By powering the electric technology combinations using renewable energy, the system will eliminate the total cost of ownership for the electric products over time. Offering geographically valued combinations of electric technologies at a fraction of the cost will better integrate electric alternatives, feasibly capable of replacing a large portion of the petroleum based products.

Fundamentally utilizing the affordable electric technology combinations will thereby serve local communities. By reducing or eliminating society's laborious efforts to maintain and/or operate petroleum-based products, the disclosed system provides electric alternatives that replace those laborious efforts with developmental opportunities at a fraction of the cost.

Restructuring the availability of electric technologies in an effort to be affordable, additional renewable energy sources are positioned to provide power to the technology combinations. Utilizing additional renewable energy sources, the technology combinations can greatly contribute to decarbonization efforts, increasing over time as the electric technologies continue to advance.

Using renewable energies to power combined electric technologies to societies convenience, the technology combinations can effectively employ affordable, decarbonizing solutions capable of simplifying daily tasks of users, providing safer transportation, accelerating education, and protecting human health.

By way of the disclosed system and method, increased amounts of the population are able to afford to explore exclusive electric technologies without requiring purchasing the products.

Thus, the disclosed system (which can be referred to the “Better Rent and the Decentralized Asset Rental Management System” (DARMS)) is a rental management platform that utilizes geolocation, blockchain, smart contracts, and NFT technology to provide a secure and efficient solution for property owners and renters, as illustrated in FIG. 4. As shown DARMS includes one or more assets (e.g., personal items, vehicles, motorsports, watercraft, equipment, sales products, luxury items, owned vicinities, coworking spaces, jewelry, and the like. The system is decentralized, such that one or more items of an owner are decentralized into NFTs that represent each rental asset and includes a unique identification number, critical information, and allows for efficient tracking of the asset(s). A rental (e.g., smart contract) enforces predetermined rules and conditions. As a result, the need for intermediaries is eliminated. Further the transactions are secure and transparent which lowers costs to users. The management system includes backend servers that employs IPFS (InterPlanetary File System) for storage. Asset data (such as photos, descriptions, and other specific details) can be easily stored. The management system also defines API endpoints and can be configured to redact native for mobile application develop (front end).

The platform comprises a centralized database, user-friendly interface, integrated reservation and payment system, comprehensive review and rating system, direct communication tools, advanced reporting and analytics, and a mobile application. DARMS uses NFTs to efficiently track and verify ownership of rental assets. Each rental asset is assigned a unique identification number that is linked to an NFT, enabling efficient tracking and verification of ownership. The platform uses smart contracts to automate the rental process and enforce predetermined rules and conditions, eliminating the need for intermediaries. The smart contracts are implemented using established programming languages such as Solidity™ or Vyper™ and are capable of enforcing the predetermined conditions for each rental transaction.

The implementation of blockchain technology in DARMS creates a decentralized and secure ledger for the storage of rental information, ensuring transparency and accountability in all transactions. The ledger maintains a tamper-proof and permanent record of all transactions, providing a secure and efficient means of managing rental assets. The DARMS platform provides a centralized database that enables property owners to manage their rental assets in one place. The user-friendly interface allows property owners and renters to easily access rental information and management tools. The integrated reservation and payment system streamlines the rental process, allowing renters to reserve and pay for rental assets in one place. The comprehensive review and rating system enables renters and property owners to make informed decisions based on the experiences of previous users. The direct communication tools allow renters and property owners to communicate directly and efficiently throughout the rental process. The mobile application provides convenient and easy access to rental information and management tools on-the-go.

The disclosed platform uses NFTs to efficiently track and verify ownership of rental assets. The NFTs are created using blockchain platforms such as Ethereum and stored in the decentralized ledger for ease of tracking and verification. The platform utilizes smart contracts to automate the rental process and enforce predetermined rules and conditions, eliminating the need for intermediaries. The smart contracts are implemented using established programming languages and are capable of enforcing the predetermined conditions for each rental transaction. The smart contracts implement functions such as asset registration, asset leasing, payment processing, and dispute resolution. These functions can be executed by the Ethereum Virtual Machine (EVM), a decentralized runtime environment that executes the smart contract code on the Ethereum blockchain. The implementation of blockchain technology in DARMS creates a decentralized and secure ledger for the storage of rental information.

The rental information is stored in the Ethereum blockchain, which uses a distributed network of nodes to maintain the integrity and security of the ledger. The platform uses the InterPlanetary File System (IPFS) to store asset data such as photos, descriptions, and specifications. The IPFS is a distributed file storage system that uses a content-addressed method to ensure data integrity and availability. The platform architecture is designed to be scalable and performant, with potential bottlenecks mitigated by the use of efficient data structures and algorithms. The platform uses caching mechanisms to reduce database access times and utilizes load balancing to distribute traffic to multiple servers. The platform is secured by the use of encryption, access control, and auditing.

The platform also has the ability to integrate with other blockchain-based systems, such as decentralized finance (DeFi) protocols or identity management solutions. The platform has been designed with potential attack vectors and security risks in mind, with measures taken to mitigate them. The platform uses encryption to secure user data, access control to restrict access to sensitive functions, and auditing to monitor and track activity on the platform. The platform is also designed to be compliant with data privacy and consumer protection laws. The advanced reporting and analytics functionality of the platform is achieved through the use of data preprocessing, feature extraction, and machine learning models. The platform preprocesses rental data to extract useful features such as rental rates, occupancy rates, and customer reviews. These features are then used to train machine learning models that can predict future rental trends and provide valuable insights for property owners.

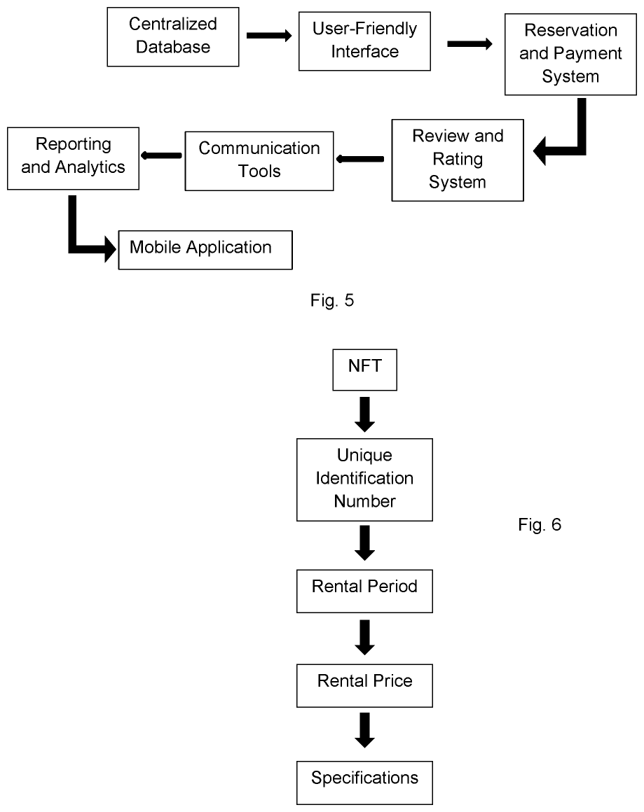

As illustrated in the schematic of FIG. 5, the presently disclosed subject matter includes a powerful and comprehensive rental management solution. The Centralized Database serves as the backbone of the system, enabling a user-friendly interface to provide seamless and intuitive rental asset management. A Reservation and Payment System streamlines the rental process, allowing renters to easily secure and pay for their rental properties. The Review and Rating System enhances transparency and accountability, enabling users to share feedback with other members of the platform. Direct communication tools facilitate efficient and direct conversations between property owners and renters. The Reporting and Analytics feature provides real-time monitoring of the rental process, offering data-driven insights to optimize rental operations. The Mobile Application offers users the flexibility to access the platform on-the-go, at any given time and/or location.

In some embodiments, NFTs can play a powerful and secure role in the disclosed rental management process. For example, as shown in FIG. 6, each NFT can include a Unique Identification Number that provides an immutable and secure record of the rental asset. Critical information such as the Rental Period, Rental Price, and/or Specifications of the rental asset can also be included in the NFT, allowing efficient tracking of rental asset ownership, and enhancing transparency and accountability throughout the rental process.

The unique platform offers innovative solutions that address the limitations of traditional rental management systems in diverse fields such as luxury rentals, equipment rentals, vehicle rentals, and real estate rentals. The advanced features of the platform, including a comprehensive review and rating system, integrated reservation and payment system, direct communication tools, and advanced reporting and analytics, enable renters and property owners to have a seamless, efficient, and secure rental experience. For example, DARMS can be used to manage high-end luxury rentals, such as yachts, private jets, and vacation homes, utilizing its advanced review and rating system to enhance transparency and accountability for both parties. Accordingly, the disclosed system allows property owners to earn passive income through rental of any of a wide variety of products (e.g., clothing, jewelry, baby products, motorcycles, lawnmower, etc.). The user-friendly interface, direct communication tools, and review system enhance trust and reliability between users.

Additionally, DARMS can be applied to equipment rentals, such as construction equipment or medical equipment, improving the efficiency and cost-effectiveness of managing assets with its integrated reservation and payment system, direct communication tools, and advanced reporting and analytics. Similarly, vehicle rentals such as cars, boats, and motorcycles, can be managed using DARMS' use of NFTs and smart contracts to ensure secure and transparent management of the rental process. Furthermore, DARMS can be used to manage real estate rentals, such as apartments and houses, utilizing its centralized database, user-friendly interface, comprehensive review and rating system, and advanced reporting and analytics. With its customizable platform, DARMS offers tailored solutions that cater to diverse asset types and user needs, while its advanced technology and comprehensive features provide secure and efficient management of rental assets of all kinds.

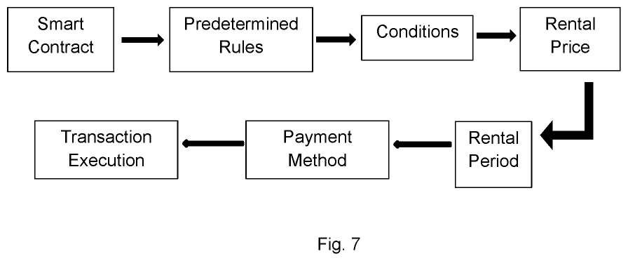

As depicted in FIG. 7, the disclosed system and method can further include the use of smart contracts, highlighting the benefits of automating rental transactions. The Smart Contract includes Predetermined Rules and Conditions that must be met before a rental transaction can occur. Solidity™ or Vyper™ programming language (among others) can be used to define the associated rules and conditions, which include essential details such as Rental Price, Rental Period, and/or Payment Method. Once all conditions are met, the Smart Contract automatically executes the Transaction, eliminating the need for intermediaries and thereby reducing costs. Such an approach offers a streamlined and secure rental process, enabling property owners and renters to enjoy a hassle-free and cost-effective rental experience.

Accordingly, DARMS represents a unique offering in the field of rental management as it is the first platform to incorporate blockchain, smart contracts, and NFT technology. The integration offers numerous advantages, including improved security, transparency, and accountability, and streamlined rental processes. DARMS has the potential to disrupt the traditional rental management systems by eliminating intermediaries, enhancing security, and simplifying the rental process. The technology has the potential to reduce costs for both renters and property owners and increase the efficiency of the rental process. Additionally, existing companies that depend on “product sales” can now have a new means of generating revenue, while still maintaining primary ownership of their items, and increasing the target market, all without having to create a new business model.

In some embodiments, the system can include an augmented reality (AR) preview capability for rental items. The AR feature employs the latest technology to provide a fully immersive and interactive experience for users, allowing them to preview rental items before committing to a rental agreement. By utilizing the AR feature, renters can obtain a more comprehensive view of rental items, providing them with a better understanding of the items' features and condition. Renters can use their mobile devices to scan the unique identifier code (NFT) of the rental item and view it in AR, which allows them to envision how the item will appear and fit in their intended location. The AR feature eliminates the need for in-person visits to the rental store, thereby reducing the time and energy required for rental transactions. Moreover, the AR feature presents an opportunity for rental stores to showcase their rental items in a more engaging and interactive manner, potentially leading to increased customer satisfaction and confidence, resulting in improved rental conversions and repeat business. Rental stores can also leverage the AR feature to gather valuable insights into customer preferences and behavior, enabling them to optimize their rental inventory and pricing strategies. In conclusion, the AR feature is a notable addition to the rental management system outlined in the provisional patent application. It offers a unique and immersive rental experience for users, elevating customer satisfaction and trust. The AR feature is a forward-thinking and cutting-edge approach to rental management that can provide significant benefits to both renters and rental stores.

The disclosed system and method offer many benefits. For example, electric technology provides a significant reduction of local air pollution because they do not emit exhaust pollutants, such as volatile organic compounds, hydrocarbons, carbon monoxide, ozone, lead, and various nitrogen oxides. The sourcing of fossil fuels (oils wells to gasoline tanks) causes extensive environmental damage and use of natural resources during the extraction and refinement processes.

The cost of purchasing and maintaining electric technologies is high due to the soaring prices of battery materials, etc. Thus, the burden on the user can be reduced by using a bundled rental system.

The geographically valued system serves local communities where the facilities and access points are physically located. The signature “Do Only Good Everywhere” process is capable of making thousands of expensive electric technologies affordably accessible to millions of additional users in the general population.

In addition, by allowing more users access to electric technologies, the relationship between society and technology is expanded. Thus, with proper integration of the electric products, the general population can regularly afford to participate in eco-friendly alternatives to petroleum-based products.

The disclosed system allows access to a wide variety of decarbonizing electric technologies. As a result, the system provides a method a environmentally and economically stabilizing our society better than petroleum-based products currently are.

Further, DARMS provides a groundbreaking technological solution that is capable of improving the rental management industry. By uniting people in local areas around the globe, a user can eliminate the “total cost-of-ownership” by making thousands of already-purchased items readily available to use for millions of additional people that would not have been able to use them otherwise, and at a fraction of the price it would have been for them to buy that/those particular rental assets.

Additionally, the disclosed platform can serve companies that depend on “sales,” allowing them to generate new revenue from their sales-products, making their items for rent, maintaining ownership, and expanding their target markets.

The platform offers numerous applications for the management of diverse asset types including typical sales products, vehicles, equipment, luxuries, and other rental assets.

The platform is suitable for a large target market of owners and renters. For example, suitable owners can include (but are not limited to) homeowners, second home owners, vacation rental owners, property management companies, real estate agents, real estate investors, building owners, high end fashion stores, luxury fashion boutiques, jewelry stores, equipment rental companies, event rental companies, product manufacturers, wholesalers, distributors, vehicle owners, lawn product owners (e.g., mowers), and the like. Similarly, suitable renters can include (but are not limited to) students, young professionals, freelancers, families, retirees, short-term renters, long-term renters, corporate renters, stylists, fashion photographers, fashion bloggers, models, event planners, contractors, construction workers, videographers, small businesses, online sellers, pop-up shops, marketers, and the like.

DARMS provides a simplified and transparent rental process, removing intermediaries, reducing costs, and improving security.

The platform also provides a centralized database, user-friendly interface, integrated reservation and payment system, comprehensive review and rating system, direct communication tools, advanced reporting and analytics, and a mobile application, which enhances the rental experience for both property owners and renters.

The platform's use of NFTs, smart contracts, and blockchain technology provides an efficient, secure, and decentralized solution that ensures accountability, transparency, and data integrity.

The disclosed system and method enhances the sharing economy by using ridesharing, carsharing, bike sharing, coworking, and co-living spaces and unique rental opportunities to offer approved users access to shared resources.

The presently disclosed subject matter promotes unification within individual communities, reducing carbon footprint and creating a one stop shop for all rental needs.

The unique combination of blockchain, smart contracts, and NFT technologies create a system capable of taking a reduced commission fee (e.g., 5%) for full sustainment (typical rental management companies charge an average of 10-50%).

Additionally, the machine learning models of the platform enable property owners to make data-driven decisions that can improve rental yields and provide valuable insights.

Exemplary embodiments of the methods and components of the presently disclosed subject matter have been described herein. As noted elsewhere, these embodiments have been described for illustrative purposes only, and are not limiting. Other embodiments are possible and are covered by the presently disclosed subject matter. Such embodiments will be apparent to persons skilled in the relevant art(s) based on the teachings contained herein. Thus, the breadth and scope of the present invention should not be limited by any of the above-described exemplary embodiments but should be defined only in accordance with the following claims and their equivalents.

### EXAMPLES

### Prophetic Example 1

### Rental of Personal Items

Individuals can use the app to rent out their personal items, such as cameras, musical instruments, sports equipment, and more, to earn passive income. The use of NFTs ensures the authenticity and ownership of the rental item, while the smart contracts automate the rental process, eliminating the need for intermediaries. The direct communication tools allow for efficient and direct conversations between the owner and the renter, while the review and rating system enables users to share feedback with other members of the platform. When a user enters a search query (e.g., by zip code, location, product description), the application makes an HTTP request to the backend API to retrieve a list of matching rental properties that are displayed to the renter in a grid or list view. The user can then filter and/or sort results based on various criteria, such as price, location, rental type, etc. A user then reserves the rental and pays securely online. The rental is held until a predetermined and agreed upon delivery or pickup date for the rented item(s). The rental is returned on time when the rental period has ended.

### Prophetic Example 2

### Renting of Luxury Items

A high-end fashion store can use the A Better Rent App to offer their customers the option to rent luxury items such as designer handbags or jewelry. The use of NFTs ensures the authenticity and ownership of the rental item, while the smart contracts automate the rental process, eliminating the need for intermediaries. The store can easily manage their inventory and update rental prices through the centralized database, while the user-friendly interface provides a seamless rental experience for customers. The direct communication tools allow for efficient and direct conversations between the store and the renter, while the review and rating system enables users to share feedback with other members of the platform.

### Prophetic Example 3

### Renting of Vehicles

A car rental company can utilize the A Better Rent App to offer their customers a streamlined and efficient rental process. The use of NFTs ensures the ownership and condition of the rental vehicle, while the smart contracts automate the rental process, eliminating the need for intermediaries. The integrated reservation and payment system streamlines the rental process, allowing renters to easily reserve and pay for their rental vehicle. The car rental company can use the reporting and analytics feature to monitor rental operations and optimize their business strategy. The direct communication tools enable efficient and direct conversations between the rental company and the renter, enhancing customer satisfaction.

### Prophetic Example 4

### Renting of Equipment

An equipment rental company can use the A Better Rent dApp to offer their customers a secure and efficient means of renting equipment. The use of NFTs ensures the ownership and condition of the rental equipment, while the smart contracts automate the rental process, eliminating the need for intermediaries. The rental company can use the advanced reporting and analytics feature to track the performance of their rental assets and optimize their rental operations. The direct communication tools allow for efficient and direct conversations between the rental company and the renter, while the review and rating system enables users to share feedback with other members of the platform.

### Prophetic Example 5

### Renting of Sales Products

A company that depends on product sales can utilize the A Better Rent App to offer their customers the option to rent their products. The use of NFTs ensures the ownership and condition of the rental item, while the smart contracts automate the rental process, eliminating the need for intermediaries. Sales companies that intend to effectively use A Better Rent's services will not have to create their own business model in order to generate additional revenue.

### Prophetic Example 6

### Event Rentals

The A Better Rent App can be used for event rentals, where individuals can rent out their event space, equipment, or decorations. For example, a person can rent out their backyard for a wedding ceremony or their sound system for a party. The use of NFTs ensures the ownership and condition of the rental item, while the smart contracts automate the rental process, eliminating the need for intermediaries. The direct communication tools allow for efficient and direct conversations between the renter and the owner, while the review and rating system enhances trust and reliability between users.

### CONCLUSION

The disclosed system has numerous potential uses for the rental of various types of assets, including personal items, co-living spaces, and event rentals. The use of blockchain, smart contracts, and NFTs offer a unique and innovative approach to rental management, reducing costs and eliminating intermediaries. The app can be customized to suit the needs of different users and asset types, providing a scalable and performant solution for rental management.

What is claimed is:

1. A method for bundling and renting one or more electric technologies, the method comprising:
receiving via a communication interface, from each of a plurality of electric technologies made available for use on demand, data representing one or more of a location and an availability state of the electric technologies; and
using a processor to use the received location and availability state data to determine a set of electric technologies currently available to be used and provide via the communication interface to each of a plurality of user data indicating the respective locations of one or more electric technologies currently available for use by the user within an area of interest associated with the user.

2. The method of claim 1, wherein the plurality of electric technologies is provided within a local geographic region of the user, and wherein the local geographic region is about 50, 40, 30, 20, 10 or less miles from the location of the user.

3. The method of claim 1, wherein the electric technology is selected from a combination of 2, 3, 4, 5, or more electric technologies selected from electric cars, electric trucks, electric motorcycles, electric boats, electric jet skis, electric buggies, electric go-karts, electric motorsports, electric scooters, electric three-wheelers, electric agricultural equipment, electric off-road vehicles, electric artificial intelligence robots, electric virtual reality/augmented wearable gear, or combinations thereof.

4. The method of claim 1, further comprising NFT technology configured for use as discounted coupons used towards rental of the electric technologies, wherein the NFTs can be transferred, traded, tracked, utilized, or combinations thereof.

5. A system for managing the bundling and renting of one or more electric technologies, the system comprising:
a communication interface;
a processor coupled to the communication interface and configured to:
receive via the communication interface from each of a plurality of electric technologies made available for use representing one or more of a location and an availability state of the vehicle;
use the received location and availability data to determine a set of electric technologies currently available to be selected;
provide data indicating the availability data to the user;
wherein the user selects one or more electric technologies to rent in exchange for the payment of a fee.

6. The system of claim 5, wherein the plurality of electric technologies is provided within a local geographic region of the user, and wherein the local geographic region is about 50, 40, 30, 20, 10 or less miles from the location of the user.

7. The system of claim 5, wherein the electric technology is selected from a combination of 2, 3, 4, 5, or more individual electric technologies selected from electric cars, electric trucks, electric motorcycles, electric boats, electric jet skis, electric buggies, electric go-karts, electric motorsports, electric scooters, electric three-wheelers, electric agricultural equipment, electric off-road vehicles, electric artificial intelligence robots, electric virtual reality/augmented wearable gear, or combinations thereof.

8. A rental management system comprising a decentralized platform that utilizes blockchain, smart contracts, and NFTs to provide a rental process for property owners and renters.

9. The rental management system of claim 8, wherein the system comprises a centralized database that enables a user-friendly interface to provide rental asset management.

10. The rental management system of claim 8, wherein the system comprises an integrated reservation and payment system that allows renters to secure and pay for one or more rental properties.

11. The rental management system of claim 8, wherein the system comprises a comprehensive review and rating system that enhances transparency and accountability, enabling users to share feedback with other members of the platform.

12. The rental management system of claim 8, wherein the system comprises direct communication tools that facilitate efficient and direct conversations between property owners and renters.

13. The rental management system of claim 8, wherein the system comprises advanced reporting and analytics features that provide real-time monitoring of the rental process, offering data-driven insights to optimize rental operations.

14. The rental management system of claim 8, wherein the system comprises a mobile application for the management of rental assets, offering users the flexibility to access the platform on-the-go, anytime and anywhere.

15. The rental management system of claim 8, wherein each NFT includes a unique identification number that provides an immutable and secure record of the rental asset, and critical information such as the rental period, rental price, and specifications of the rental asset, allowing efficient tracking of rental asset ownership and enhancing transparency and accountability throughout the rental process.

16. The rental management system of claim 8, wherein a smart contract is used to automate the rental process and enforce predetermined rules and conditions selected from rental price, rental period, and payment method, reducing the need for intermediaries and lowering costs.

17. The rental management system of claim 8, wherein the system is used to manage the rental of various types of assets and is customized to suit the needs of different users and asset types.

18. The rental management system of claim 8, wherein the incorporation of augmented reality technology further enhances the user experience by providing a fully immersive and interactive experience for users to preview rental items before committing to a rental agreement.
